(19) United States
(12) Patent Application Publication
(10) Pub. No.: US 2006/0015599 A1
(43) Pub. Date: Jan. 19, 2006

(54) Multi-layer video management and display method carried out on the networks

(76) Inventors: Shih Ter Li, Hsinchu (TW); Barney Chu, Hsinchu (TW); Chen Lung Chen, Hsinchu (TW); Chi Sheng Cheng, Hsinchu (TW); Chih Feng Liou, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/107,756

(22) Filed: Apr. 18, 2005

(30) Foreign Application Priority Data
Jun. 30, 2004 (TW) 93119626

(51) Int. Cl. G06F 15/173

(52) U.S. Cl. 709/223

(57) ABSTRACT

In a multi-layer video management and display method carried out on the networks, configuration parameters are set for a plurality of nodes on the networks so that these nodes can be divided into several father layers and several son layers. A root is also set for a network matrix mode. Connection between every two nodes is achieved through the network. The root registers to a registry center to get an authorized number of nodes. Each node then gets authorization from the root. A node therefore can remotely control the nodes at son layers belonging to it and get video images via the networks to accomplish easy expansion and integration and also have the advantages of providing distributed architecture and central management.

### FIELD OF THE INVENTION

The present invention relates to a network monitoring method and, more particularly, to a multi-layer image management and display method carried out on the networks.

### BACKGROUND OF THE INVENTION

Generally speaking, surveillance management systems mainly include access control systems, alarm/burglarproof systems, and video monitoring systems. The surveillance management system integrates the techniques of camera video input, image processing, and video display. Today, the video monitoring systems in common use are analog closed-circuit television (CCTV) monitoring systems. Although the CCTV monitoring systems have the drawbacks of storing data on the video tapes, signal attenuation and bad image quality etc., they still predominate due to their low prices. On the other hand, along with the digitization and the increase of the requirements for remote monitor, digital video management systems have become the development trend in the future surveillance market. Therefore, analog signal and digital signal based video monitoring systems currently coexist.

Along with the expansion of industry scales and the development of business globalization, remote monitoring is becoming a trend. Video monitoring systems, however, will derive problems in storage, distribution of video data and network bandwidth due to dispersion of monitoring sites and of a large number of monitoring sites, hence causing such troubles as difficult expansion of system, difficult integration and inconvenient management in practical application.

Accordingly, the present invention aims to propose a matrix mode multi-layer video management and display method carried out on the networks for effectively solving the above problems in the prior art.

### SUMMARY OF THE INVENTION

An object of the present invention is to provide a multi-layer video management and display method carried on the networks, whereby data transmission and management can be accomplished in a succession of series connection mode or/and a succession of parallel connection mode to substantially expand the system without losing its integrity, hence accomplishing the effect of easy expansion and integration.

Another object of the present invention is to provide a multi-layer video management and display method carried on the networks, whereby the advantage of concentration and dispersion of nodes can be accomplished to effectively solve the problems in storage and distribution of image data and network bandwidth due to dispersion of monitoring sites and a large number of monitoring sites in the prior art.

In order to manage a plurality of nodes, the present invention proposes a multi-layer video management and display method carried on the networks. The method comprises the following steps. First, configuration parameters are set for these nodes to establish a classification system including several father layers and several son layers. A root is also set for a network matrix mode to manage other nodes. Connection between every two of the nodes is accomplished through the networks. Next, the root registers to a registry center to get an authorized number of nodes, and each of the nodes then gets authorization from the root for managing the nodes at the son layers belonging to it. After setting and authorization, video images can be got from one of the nodes or nodes at or above its father layer via the networks.

The various objects and advantages of the present invention will be more readily understood from the following detailed description when read in conjunction with the appended drawing, in which:

### BRIEF DESCRIPTION OF THE DRAWINGS

FIG. 1 is a flowchart of a multi-layer image management and display method of the present invention;

FIG. 2 is a tree structure diagram showing the arrangement of nodes of the present invention;

FIG. 3 is a diagram showing the relationship between video management nodes of the present invention; and

FIG. 4 is a node arrangement diagram according to an embodiment of the present invention.

### DETAILED DESCRIPTION OF THE PREFERRED EMBODIMENTS

The present invention bases on a matrix arrangement for data transmission and management to substantially expand the system without losing its integrity and also have the advantage of concentration and dispersion of nodes.

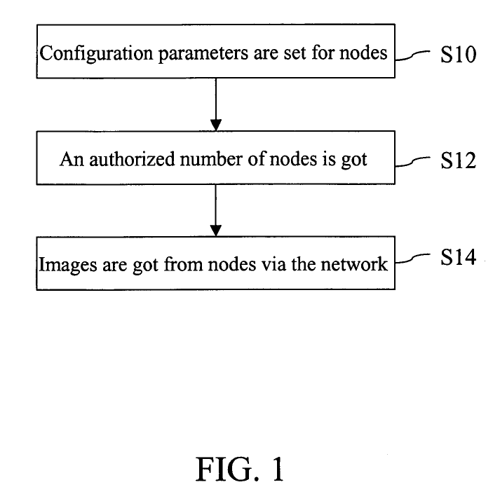

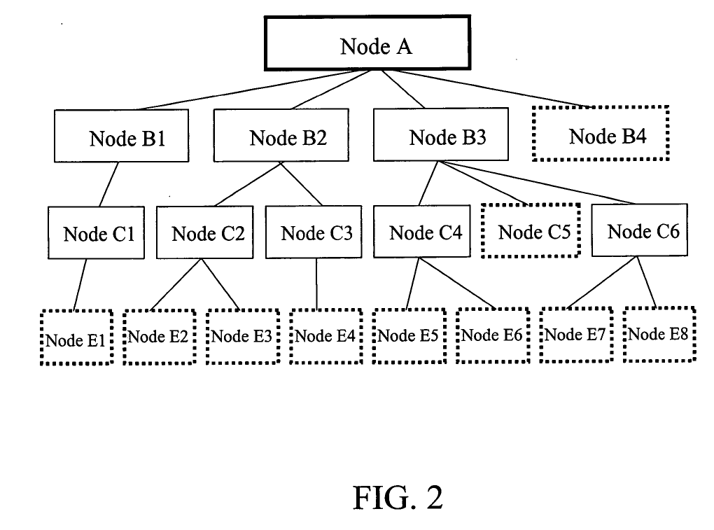

A video management system connects a plurality of nodes via a network. Each node has a safety control device, usually being a video image management server. The networks include the Internet and the Intranet. As shown in FIG. 1, a multi-layer video management and display method carried on the networks of the present invention comprises the following steps. First, configuration parameters are set for these nodes to establish management policies and a classification system of these nodes (Step S10). The classification system relates to the arrangement of a tree structure relation, as shown in FIG. 2. Each video management server is a node. This tree structure includes several father layers and several son layers. A root is set for a network matrix mode. The root can be a host server to manage other nodes. Connection between every two nodes is accomplished through the networks. A node having no father layer (e.g., node A) is used for a network matrix mode. A node having no son layer (e.g., node B4, C5, or E1 to E8) is called a leaf.

After setting configuration parameters of nodes to form a tree structure, the root registers to a registry center to get an authorized number of nodes (Step S12). Each node then gets authorization from the root to manage nodes at the son layers belonging to it. After all the nodes get authorization, video images can be got from one of the nodes or nodes at or above its father layer or other data can be acquired at the same time of getting the video images via the networks (Step S14).

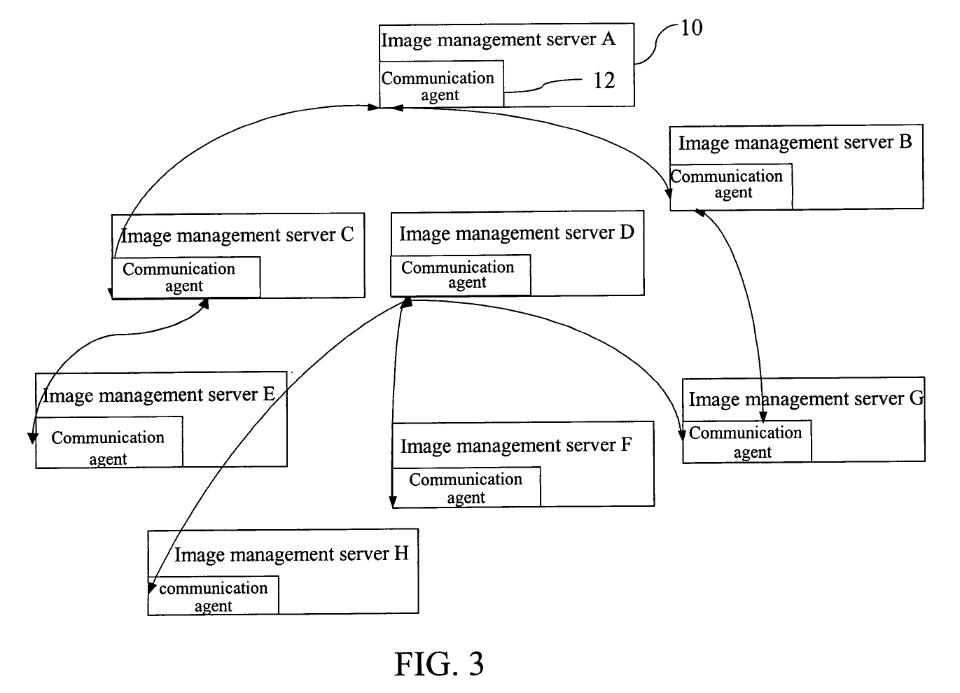

As shown in FIG. 3, each image management server 10 has a communication agent 12 responsible for communication between servers 10. The classification system in Step S10 is set and defined by user. For instance, Server A can communicate with Server B and Server C, and a viewer connected with Server A can view video images captured by Server B. Each server 10 can simultaneously perform message communication with at least another server 10. For instance, Server B can communicate with Server A and Server G. Besides, a server used as a father node can be simultaneously used as a son node at another son layer. A viewer connected with the father node can view video images captured by son nodes managed by the father node.

In Step S10, the management policies are set and defined by users. For instance, through setting of configuration parameters, a first node can monitor a third node through a second node. Speaking more specifically, a viewer connected with Server A can view video images captured by Server G through Server B. Besides, through setting of the management policies, the second third can block/allow the first node to view video images and data of the third node. Speaking more specifically, if there are two cameras connected to Server G, through setting of the management policies, the communication agent of Server G can block or allow the viewer connected with Server A to view video images of these two cameras or one of them through Server B.

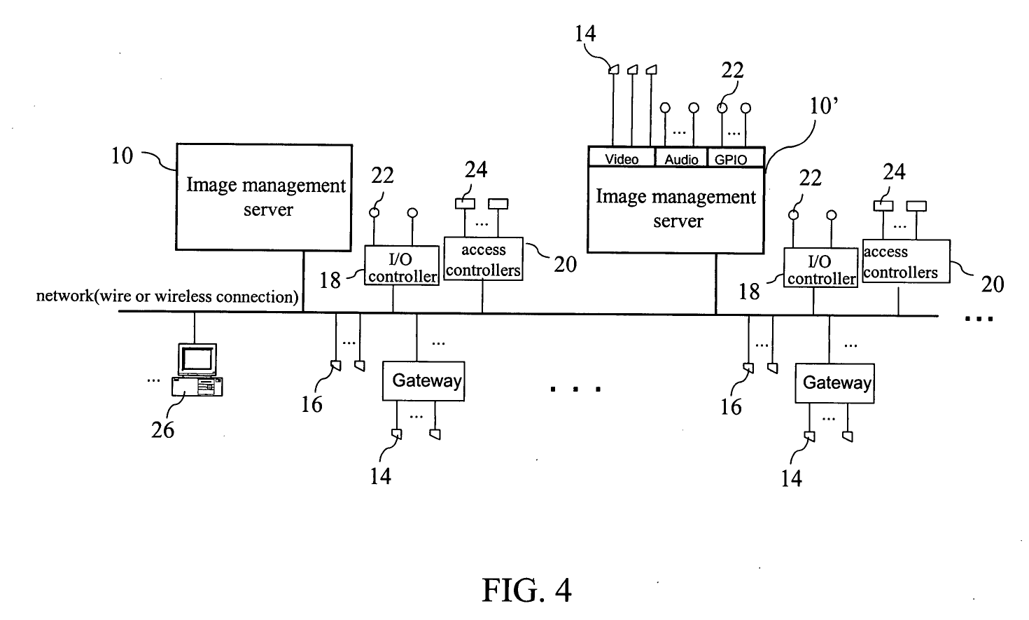

As shown in FIG. 4, two video management servers 10 and 10′ are connected together through the networks. The networks can be the Internet or an intranet. These two video management server 10 and 10′ are two nodes, which are used to govern several security control devices including analog cameras 14, digital cameras 16, I/O controllers 18, and access controllers 20. The video management server 10 is also connected with a viewer 26. Each digital camera 16 has an IP address assigned to it. The video format of the digital camera 16 is usually MPEG, MPEG2, MPEG4, H.263, or H.264. The video format of the analog camera 14 is either NTSC or PAL.

The I/O controller 18 is used to connect several components 22 including detectors, emergency push-buttons, alarms and indication lights. The detector can be a magnetic switch, smoke detector, temperature sensor, gas detector, flame detector, carbon monoxide detector or poisonous gas detector. The access controller 20 is used to connect several card readers 24 for access card reading. In addition to viewing video images captured by a camera connected with the video management server 10, the viewer 26 can also view another remote video management server 10′ through the networks and based on the above video management and display method. Moreover, cameras 14 and 16, detectors, and access card readers belonging to the same node can communicate mutually through control of the video management server 10 or 10′.

To sum up, the multi-layer video management and display method carried out on networks of the present invention makes use of the connections between the management servers to accomplish data transmission and management for substantially expanding the system without losing its integrity. The present invention also has the advantages of providing flexible and expandable architecture. Moreover, the present invention can effectively solve the problems in storage, distribution of video data and network bandwidth due to dispersion of monitoring sites and of a large number of monitoring sites in the prior art.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multi-layer video management and display method carried on the networks for managing a plurality of nodes on the networks, each said node having a security control device, said method comprising the steps of:
setting configuration parameters for said nodes to establish management policies and a classification system of said nodes, said classification system including several father layers and several son layers, a root being set for a network matrix mode to manage other said nodes, connection between every two of said nodes being accomplished through said networks;
said root registering to a registry center to get an authorized number of nodes, each said node then getting authorization from said root to manage nodes at the son layers belonging to it; and
getting video from one of said nodes or nodes at or above its father layer via said networks.

2. The multi-layer video management and display method carried on the networks as claimed in claim 1, wherein said node is a video management server.

3. The multi-layer video management and display method carried on the networks as claimed in claim 1, wherein said networks include the Internet and an intranet.

4. The multi-layer video management and display method carried on the networks as claimed in claim 1 further comprising a step of getting data from the node to which said security control device belongs or nodes at or above its father layer in said step of getting video images from one of said nodes or nodes at or above its father layer via said network.

5. The multi-layer video management and display method carried on the networks as claimed in claim 1, wherein said management policies are set by users.

6. The multi-layer video management and display method carried on the networks as claimed in claim 1, wherein said classification system is set by users.

7. The multi-layer video management and display method carried on the networks as claimed in claim 1, wherein nodes at said father layer can simultaneously communicate messages with at least a node at the corresponding son layer.

8. The multi-layer video management and display method carried on the networks as claimed in claim 1, wherein a node at said father layer can be simultaneously used as a node at said son layer.

9. The multi-layer video management and display method carried on the networks as claimed in claim 1, wherein said security control system connected to a node at said father layer can be used to browse video images captured by nodes at said son layer managed by said security control system.

10. The multi-layer video management and display method carried on the networks as claimed in claim 1, wherein a first node can monitor a third node via a second node through setting of said management policies.

11. The multi-layer video management and display method carried on the networks as claimed in claim 10, wherein said second node can block/allow said first node to browse video images and data of said third node.

12. The multi-layer video management and display method carried on the networks as claimed in claim 1, wherein said root is selected from said nodes.

13. The multi-layer video management and display method carried on the networks as claimed in claim 1, wherein said security control devices governed by the same node can communicate mutually.

14. The multi-layer video management and display method carried on the networks as claimed in claim 1, wherein said security control devices are selected from the group composed of analog cameras, digital cameras, access card readers, detectors, emergency push-buttons, alarms, and indication lights.

15. The multi-layer video management and display method carried on the networks as claimed in claim 14, wherein the video format of said analog camera is either NTSC or PAL.

16. The multi-layer video management and display method carried on the networks as claimed in claim 14, wherein the video format of said digital camera is MPEG, MPEG2, MPEG4, H.263 or H.264.

17. The multi-layer video management and display method carried on the networks as claimed in claim 14, wherein said detectors comprise at least one selected from the group composed of magnetic contacts, infrared detectors, microwave spatial detectors, glass vibration detectors, smoke detectors, temperature sensors, gas detectors, flame detectors, carbon monoxide detectors and poisonous gas detectors.

18. The multi-layer video management and display method carried on the networks as claimed in claim 1, wherein said classification system relates to the arrangement of a tree structure relation.

19. The multi-layer video management and display method carried on the networks as claimed in claim 1, wherein each of said father layers has at least one of said nodes.

20. The multi-layer video management and display method carried on the networks as claimed in claim 1, wherein each of said son layer has at least one of said nodes.
